(19) United States
(12) Patent Application Publication
(10) Pub. No.: US 2014/0293041 A1
(43) Pub. Date: Oct. 2, 2014

(54) Method for Sensor Image Detection and Use of Such a Method in an Electrical Tool

(71) Applicant: Robert Bosch GmbH, Stuttgart (DE)

(72) Inventor: Siegbert Steinlechner, Leonberg (DE)

(21) Appl. No.: 14/355,892

(22) PCT Filed: Sep. 18, 2012
(86) PCT No.: PCT/EP2012/068334

§ 371 Date: May 2, 2014

(30) Foreign Application Priority Data
Nov. 15, 2011 (DE) 10 2011 086 419.9

(51) Int. Cl. G06K 9/32

(52) U.S. Cl. CPC G06K 9/3208
USPC 348/95

(57) ABSTRACT

A method facilitates sensor image detection of a work line that is provided on a workpiece and is to be followed with a working tool of a working device that is equipped with an image detection apparatus. The method includes detecting an image section that is adjacent to the working tool as a halftone image in relation to the working tool applied to the workpiece in a region of the working line, aligning a position of the working device approximately to the working line, and evaluating the halftone image in terms of image pixels describing the working line and lying in contact with and/or overlapping the working line in order to detect the working line.

The invention relates to a method for sensor image acquisition of a work line that is provided on a workpiece and is to be tracked by a tool of a working device.

### PRIOR ART

Handheld working devices having a tool which engages with a workpiece, and having an image acquisition device for a work line that is to be tracked by the tool and is provided on a workpiece are known, for example, from WO 2008/055738 A1. This, in particular, for working devices designed as hand operated jigsaws which can also be operated semiautonomously with the aid of the optical image acquisition device. To this end, data describing the course of the work line are obtained via the acquisition device, and are converted via a processing unit into control commands for aligning the saw blade provided as tool.

Preferably provided as an acquisition device is a 2D sensor in the form of a camera, in the case of which to detect the work line use is made of image processing which employs an ideal division of the optically acquired work area into individual work lines in order, via the processing unit, to determine the course of the work line to be tracked by the tool from individual acquired points of the work line by interpolation.

Notwithstanding such auxiliary measures, the acquisition quality cannot be satisfactory for the work line provided on the workpiece side, particularly in the event of poor contrast with the surface of the workpiece, and the work line provided on the workpiece side frequently cannot be acquired with the accuracy required for a positive result of work, and this, in particular, also in the critical application zone of the tool to the workpiece.

### DISCLOSURE OF THE INVENTION

The aim of the invention is to provide a method for sensor image acquisition of work lines on the workpiece side which improves the acquisition quality even under unfavorable conditions.

This is achieved with the aid of the features of claim 1, in relation to which the subclaims exhibit expedient developments while being explained in the description, in particular also with the aid of the drawings with refinements.

In principle, in the inventive method for sensor image acquisition, chiefly for sensor image acquisition of work lines prescribed on a workpiece surface, an image section upstream of the tool, in particular directly upstream, is acquired, specifically by acquiring the image pixels of said section in a grayscale image. Said grayscale image is ideally overlaid with a raster pattern, and the grayscale values of the image pixels of the image section are evaluated statistically with regard to extreme values occurring along the work line.

With reference to a work line prescribed for the workpiece, such image pixels result in extreme grayscale values contacting and/or overlapping the work line. Particularly in connection with different rastering, it is therefore possible to make use of different raster patterns with regard to different images to be acquired.

Thus, for example, in order to determine the application point for the tool on the workpiece, that is to say the beginning of the work line, and/or in order to acquire the work line in its further course.

Firstly, the centering of the image section takes place in the X-direction of an X-Y coordinate system, in particular a Cartesian coordinate system, in the case of an application edge on the workpiece side and running in the X-direction for the respective tool of the working device. This starting from an alignment of the working device, provided as a rule upon applying the tool to a work piece, with the initial course of the work line. Furthermore, in the case of an expediently provided alignment of raster lines in the Y-direction such that in the case of appropriately narrow rastering in the X-direction the “middle”, that is to say the application point that is optimum in relation to the work line in overlap, is prescribed solely via the comparison of the grayscale values of the image pixel lying along the X-axis, and there is no need for further centering of the image in the X-direction. With reference to the image pixels acquired in grayscale values, the “middle” is defined as that X-position in which the sum of the grayscale values of the image pixels acquired near the edge along the raster lines in the Y-direction deviates most strongly from the mean value of all summed grayscale values acquired in the Y-direction along the raster lines.

A preferred particular procedure for determining the position of the application point with reference to the image section is determined by summing the grayscale values in the Y-direction, starting at Y=0, in particular respectively for a few image pixels, in the image section for a number of X-positions of the coordinate system, and by setting as the application point the X-position for which the greatest deviation of the mean value of all the X-positions is provided in sum. Said procedure for fixing the application point is also possible according to the invention independently of the way in which the work line is subsequently tracked.

It is expedient to align the coordinate system in such a way that the X-coordinate runs as abscissa in the direction of the longitudinal edge of the workpiece which is assigned to the application point.

Starting from a fixed application point, with regard to the exact determination of the course of the work line after the image section has been centered on the application point as work line, should such a coincidence not already be provided from the start, it is expedient to operate with a rastering whose raster lines diverge from one another in fanlike fashion starting from the “middle” as application point such that, even in the case of a small acquired image section and, if appropriate, curved course of the work line, it is possible to fix a number of image pixels adequate for the course of said work line and to acquire them with regard to their grayscale values. In the case of such rastering with, as raster lines, ideal straight lines emanating from the application point rectilinearly, in particular in fanlike fashion, the grayscale values of the image pixels in contact with said straight lines are summed, and the course of the work line in the region of the image section is determined by the straight line for which the value of the sum of the image pixels has an extreme value by comparison with the sum of the values of the image pixels of the remaining straight lines.

Thus, the evaluation of the grayscale image in order to acquire the work line is performed from statistical points of view to the effect that the image pixels that make contact with the work line or overlap the work line differ at least in the sum of the grayscale values of further image pixels lying on common connecting straight lines, and form extreme values which are greater or less than the other summed values as a function of the respective brightness pairing between the mark forming the work line and the surface of the workpiece—dark line on bright surface or bright line on dark surface.

In practical operation, the inventive procedure offers the advantage of seamlessly supporting the user of the working device from starting by setting up the tool in relation to the workpiece up to guiding the tool along the work line. This applies equally to guiding the working device via the tool along the work line in autonomous or semiautonomous operation, wherein owing to the two-stage nature of the method a simple method is provided, firstly with the acquisition of the application point of the tool in relation to the workpiece and, in the second stage, by the alignment with the work line emanating from the application point, as well.

Further details and features of the invention emerge from the following drawing and the description of two with the aid of which the inventive method and the associated machine tool are additionally explained.

### DRAWING

In the drawing:

FIG. 1 shows an illustration of the work area of a compass saw in front of the saw blade with a straight work line drawn on the workpiece,

FIG. 2 shows a grayscale section from the work area in accordance with FIG. 1,

FIG. 3 shows the course of the summed value over assumed straight line slopes in accordance with the inventive method,

FIG. 4 shows the grayscale section of the work area in accordance with FIG. 2 together with plotted, calculated straight lines,

FIG. 5 shows an illustration of the work area of a compass saw in front of the saw blade together with a curved work line drawn on the workpiece,

FIG. 6 shows a grayscale section from the work area in accordance with FIG. 5,

FIG. 7 shows the course of the summed value over assumed straight line slopes in accordance with the inventive method,

FIG. 8 shows the grayscale section of the work area in accordance with FIG. 6 together with a plotted, calculated approximation straight line, and

FIG. 9 shows an inventive machine tool in the embodiment of a compass saw.

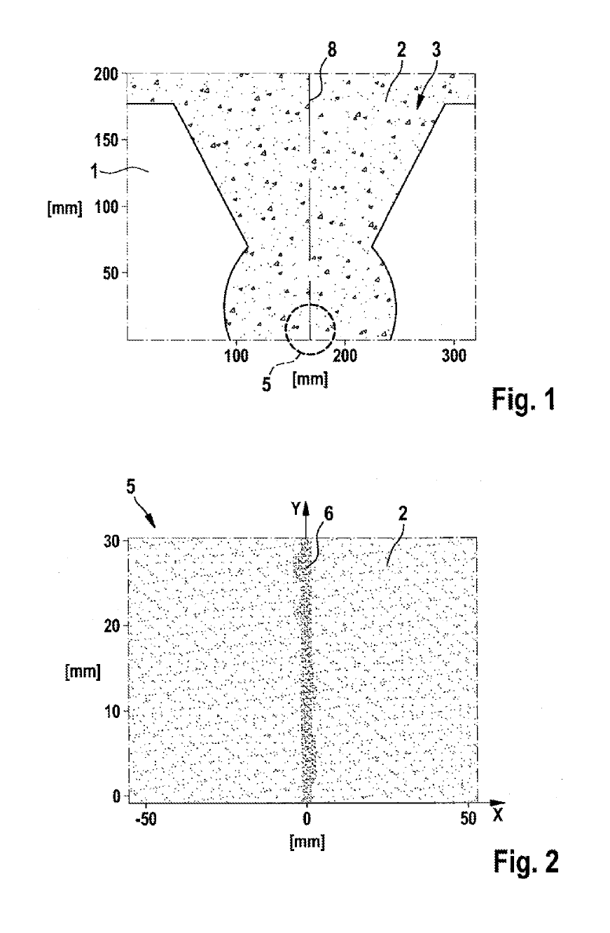

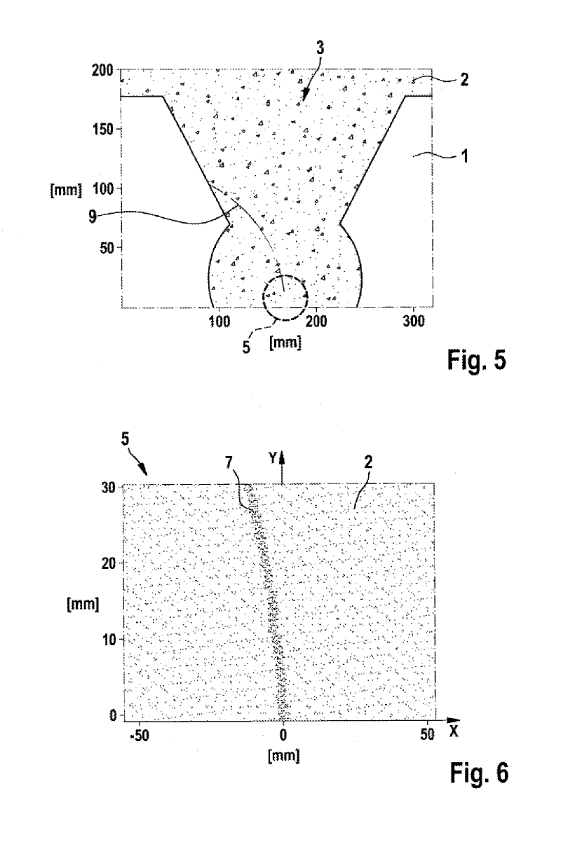

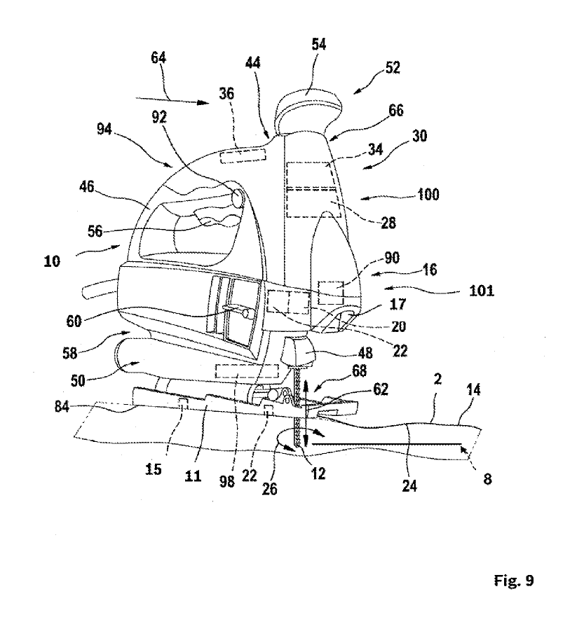

FIGS. 1 to 4 relate to a first exemplary embodiment, a substantially straight work line. FIGS. 5 to 8 describe a second exemplary embodiment of a curved work line. FIG. 9 shows an inventive electrical tool in the embodiment of a hand operated jigsaw (compass saw) which can be operated in accordance with the inventive method.

FIGS. 1 and 5 respectively show in plan view the area, lying in front of a saw blade (not illustrated) as tool, of a supporting footplate 1 of a compass saw mounted on a workpiece 2 and operating as tool with a saw blade, and the supporting footplate 1 is provided with a cutout 3 which, in relation to the saw blade, is partially surrounding and expands adjacent to said area in the working direction, and which leaves open the view onto the work line 8, 9 prescribed in relation to the surface on the workpiece 2 and emanating from an application edge on the workpiece 2 for the saw blade. In the illustration in accordance with FIG. 1, the work line 8 runs, emanating from the application point on the application edge (not illustrated) of the workpiece 2, in a straight line and substantially perpendicularly, and the work line 9 is illustrated in FIG. 5 as a curved track to be tracked by the tool.

In a first step of the inventive method, a recorded image on the work area in front of the tool, that is to say the electrical tool, is made (compare FIGS. 1 and 5). This is performed by using a sensor integrated in the device such as, for example, a CCD camera installed in the device. It is assumed in this case that the tool is already situated approximately at the correct location of the workpiece, that is to say in the vicinity of a starting point of the work line drawn on the surface of the workpiece by the user, and that the alignment of the device points approximately in the direction in which the device is to be moved in future, that is to say in accordance with its intended function.

In a second step, a section from the recorded image, in particular the area directly in front of the tool, for example a saw blade, is formed and converted into a grayscale image. Such a grayscale image has a reduced pixel number of, for example, 100*30 pixels.

A corresponding section is acquired and illustrated as a gray image in FIGS. 2 and 6. The section of FIGS. 2 and 6, respectively, corresponds substantially to the small section 5, illustrated with dashed lines in FIGS. 1 and 5, respectively, of the surface area of the workpiece 2, which lies in the area of the cutout 3 in the supporting footplate 1. The work line 8 or 9 extends with a short segment in the area of the section 5, which lies ahead of the tool, designed as a saw blade, in the working direction. In relation to the section 5 as a greatly enlarged grayscale image illustration, FIGS. 2 and 6 indicate by way of illustration an X-Y coordinate system having an X-axis running along the application edge for the tool on the workpiece 2, and a Y-axis at right angles thereto. The point of intersection on the axes X and Y coincides in the exemplary embodiment with the “middle” and therefore corresponds to the starting point of the respective work line 8, 9. If, during operation, that is to say during sawing, for example, the starting point on the work line 8, 9 is departed from as application point for the tool, the tool operates on the workpiece 2 along the work line 8, 9, thus resulting in corresponding conditions for the image section 5 respectively acquired over the course of the work line 8, 9 and acquired via the grayscale image illustrations according to FIG. 2 or 6.

The centering of the grayscale image (compare FIGS. 2 and 6) in the x-direction is performed in the third step of the method. For this purpose, the grayscale values of fewer pixels (for example, only 10 pixels) are summed in the y-direction, starting at y=0. This is performed separately for each x-position (that is to say, for example, here for: x=−50, −49, . . . , 49, 50). That x-position for which the sum deviates most strongly from the mean value of all the sums is taken as and defined as the “middle”. If a dark line is located as work line on a bright workpiece surface, the sum will be smaller than the mean value of all the sums for the x-position at which the line is located. If a bright line is located as work line on a darker workpiece surface, the sum will be greater at the line position than the mean value over all the sums. In both cases, however, the deviation from the mean value is an extreme.

Once the middle position has been found in this way, the image is centered, that is to say is displaced so far in the x-direction that the line of the work line lies at the new position x=0. This is already the case in FIGS. 2 and 6. In many cases, it is also possible to omit the third centering step just described. This is the case, in particular, whenever the machine tool and the camera alignment exhibit high mechanical precision and the machine tool is located at the correct x-position from the beginning.

With reference to the illustrations in accordance with FIGS. 2 and 6, a grayscale line 6 in FIG. 2 and a grayscale line 7 in FIG. 6 illustrates the position of the image pixel which, with reference to the image section 5, deviates most strongly in the sum of their grayscale values from the mean value of the sums of image pixels which are summed over other X-positions and which reproduce the course of the work line 8, 9 in the area acquired. In the area of the section 5, the grayscale line 6, 7 has a course which is widened in accordance with the scatterings of the image pixels in contact with the work line 8, 9, and further illustrated as a bar-like line of clustered points.

Corresponding scatterings result in the case of unclear contrast situations, different marking strengths or else partially stepped illustrations of the work line 8, 9 and, in accordance with the widening of the grayscale line 6 or 7, entail instances of lack of clarity as regards the working direction in contrast to an exactly prescribed work line 8, 9.

In a fourth step, the slope of the work line is determined in the centered coordinate system. For this purpose, straight lines through the point (x,y)=(0,0) are plotted hypothetically in the image by computation with a multiplicity of, for example 20 to 50, different, possible slopes m (defined here as m=dx/dy), and the brightness values of the pixels in contact with the respective straight line are summed along said straight line. If one of said hypothetical straight lines intersects a work line actually present in the image, the sum of the brightness values which is thus formed will have an extreme value in comparison to all other sums.

That is to say, the slope of the respective grayscale line 6 or 7 (FIGS. 4 and 6) is determined in order to specify the position of the work line, for which purpose in relation to ideal straight lines emanating like rays, in particular in fan-like fashion, from the starting point, the grayscale values of the image pixels which are in contact with said straight lines or overlap them are respectively summed. The course of the work line 8, 9 is determined in the area of the section 5 via the straight line of the fan of straight lines for which the sum value of the image pixels has an extreme value in comparison to the sum value of the image pixels of all other straight lines.

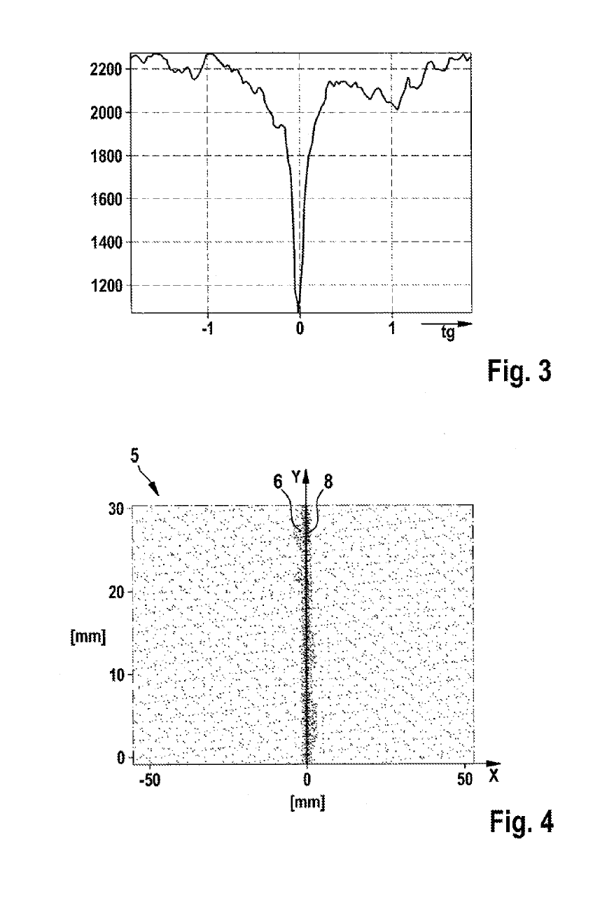

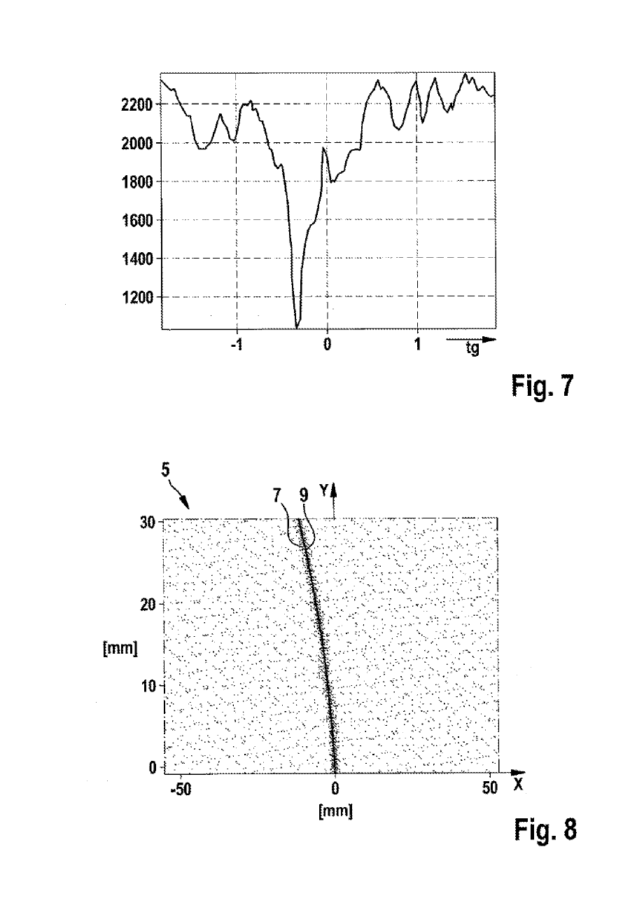

In the graphs in accordance with FIGS. 3 and 7, this is illustrated by plotting the summed grayscale values of the image pixels for the straight lines of the fan of straight lines against the slope given for the respective straight lines, from which it is possible to read out a slope, and thus the course relative to the X-axis, for the work line 8, 9 corresponding to the respective grayscale lines 6 or 7. FIG. 4 shows the course of the sum against the hypothetical straight line slope m for the first exemplary embodiment. It is seen that the slope has an extreme value at m=0. The slope m=0 thus determined was plotted in FIG. 4, and exactly matches the direction of the work line originally applied as a pencil line, for example. In contrast to the exemplary embodiment of FIGS. 1 to 4, in the case of which the course is perpendicular to the X-axis, the course is inclined at an angle to the X-axis with reference to the illustration of the second exemplary embodiment in accordance with FIG. 8, said angular positions referring to the course of the work line 8, 9 in the area of the section 5 as it is seen from FIGS. 4 and 8. Since only a few pixels are considered in the y-direction for the evaluation of the brightness sums, it follows that a work line in the form of a circular arc such as is present in the second exemplary embodiment can also be effectively approximated with a straight line segment in the area close in front of the tool of the machine.

In a fifth step of the method, the tool or the electrical tool is tracked in the direction of the calculated slope m.

In accordance with the area of the respective work line 8, 9 which is to be respectively acquired in an image section 5, the image section 5 migrates and, together therewith, so does the virtual coordinate system migrate along the further course of the work line 8, 9 with the respective “application point” of the work line 8, 9, which point lies at the point of intersection of the axes. Thus, with a movement of the electrical tool a new section 5′ comes directly in front of the tool for evaluation such that there is also a new determination of the alignment close to the area of the work line 8 or 9.

By way of example, but not exclusively, the electrical tool or working device can be a compass saw or else a milling cutter which is intended to saw or mill along an applied prescribed work line. Such a compass saw is illustrated by way of example in FIG. 9.

An inventive electrical tool, in particular a hand operated jigsaw 10 in the form of a scrolling jigsaw, is shown in a perspective side view in FIG. 9. The hand operated jigsaw 10 comprises a machine housing 44 with a main hand grip 46, integrated in the machine housing 44, and a tool holder 48 with a tool, held therein, in the form of a saw blade 12 which is arranged rotatably. A sliding element or a sliding pad 11 in the form of a footplate is arranged on a side 50 facing the workpiece 2 to be processed. Said sliding pad 11 enables an advantageous sliding of the hand operated jigsaw 10 on the workpiece 2. Arranged on the side 52 averted from the saw blade 12 in a region which can be assigned to the main hand grip 46 is a guide knob 54 which serves to provide at least manual guidance of the hand operated jigsaw 10. Furthermore, a motor, which is not illustrated in more detail, is arranged in the machine housing 44. Provided on the main hand grip 46 is an operating switch 56 by means of which the hand operated jigsaw 9 can be switched on and off. Furthermore, there is arranged in a lateral region 58 of the machine housing 44 an adjusting switch 60 via which the sliding pad 11 can be adjusted relative to a main extent 62 of the saw blade 12.

The hand operated jigsaw 10 comprises control means 100, 101 by means of which the saw blade 12 can be tracked automatically along the scribed line 8 or 9. The control means 101 is arranged in a part 66 of the machine housing 44 averted from the main hand grip 46 in an axial direction 64. The control means 101 comprises a sensor 16 for detecting or for optically acquiring a marking or scribed line 8 or 9, applied to the workpiece 18, in the form of a normal pencil line. The sensor 16 is formed by a camera unit 17 which preferably includes a low cost camera and which is assigned an arithmetic logic unit 28. The sensor 16 could physically also be a contrast sensor unit 20 and/or an eddy current sensor unit 22 to which an arithmetic logic unit 28 is respectively assigned. An arrangement of the eddy current sensor 22 in the sliding pad 11 would also be conceivable for optimum detection of the previously scribed line 8, 9.

A monitoring region 68 of a sensor 16 or of the camera unit 17 runs in the direction of the main extent 62 of the saw blade 12 up to the workpiece 18 and covers a 360° angular range around the saw blade 12. The monitoring region 68 of the camera unit 17 constitutes the region in which the saw blade 12 operates in a processing mode, preferably a sawing operation of a workpiece 18. Around the saw blade 12, the sliding pad 11 has a partially circular cutout 70 in which the saw blade 12 is centrally arranged. In the direction of a feed direction 38 or in the direction of the monitoring region 68, the cutout 70 has a rectangular inspection window 102. Furthermore, the sliding pad 11 has a reference mark 74 which marks a point of intersection of an edge 76 of the sliding pad 11 with an axis 78 of longitudinal extent of the sliding pad 11.

A control circuit for tracking the prescribed line or the scribed line 8 or 9 as exactly as possible can be implemented with the aid of the control means 100, 101, specifically the sensor 16 and the control unit 30. The special feature here resides in the automation of the system. It is thereby possible to carry out clean, straight cuts by hand and actively prevent a deviation of the saw blade 12.

An additional or alternative embodiment is the integration of a determination of a feed rate. For this purpose, there are arranged in the sliding pad 11 on a side 84 facing the workpiece 2, optical mouse sensors 15 which preferably determine the speed and a direction of movement in x- and/or y-directions.

The inventive electrical tool is not restricted to the exemplary embodiment described. In addition to the already mentioned, in particular hand guided (surface) milling cutter, it is possible to conceive of a multiplicity of electrical tools which utilize acquisition of a line according to the inventive method.

By way of example, it is also possible to have an electrical tool in the form of a sewing machine which is intended to sew along such a line. Further applications are, for example, the application of an adhesive, or the cutting of materials by means of, for example, ultrasound, laser beam or else water jet. Appropriate devices are to be understood within the scope of this application as electrical tools.

1. A method for sensor image acquisition of a work line that is provided on a workpiece and is to be tracked by a tool of a working device that is equipped with an image acquisition device, comprising:
acquiring an image section that is adjacent to the tool as a grayscale image with reference to the tool applied to the workpiece in the region of the work line; and
in order to acquire the work line, evaluating the grayscale image with regard to image pixels that at least one of:
make contact with the work line; and
lie in a fashion overlapping the work line and describe the work line.

2. The method as claimed in claim 1, wherein:
the evaluating of the grayscale image is performed at least in an environment of the work line; and
the image pixels that at least one of make contact with the work line and lie in a fashion overlapping the work line have extreme values with reference to grayscale values of the image pixels, at least in sum in relation to a sum of grayscale values of remaining image pixels.

3. The method as claimed in claim 1, wherein the evaluating includes evaluating the image section in multiple stages that include:
a first stage of acquiring an application point of the tool in relation to the workpiece; and
a second stage, with the image section centered in relation to the application point, of acquiring an alignment of the work line within the image section starting from the application point.

4. The method as claimed in claim 3, wherein acquiring the application point includes determining a position of the application point with reference to the image section by:
summing the grayscale values in the image section for a number of X-positions of a coordinate system; and
taking as the application point the X-position for which, in sum, a greatest deviation from a mean value of the sums of all the X-positions occurs.

5. The method as claimed in claim 4, wherein the grayscale values for the number of X-positions are summed in an X-direction, beginning at Y=0.

6. The method as claimed in claim 3, wherein the work line and the application point of the tool are brought into coincidence when the image section is centered in relation to the application point.

7. The method as claimed in claim 1, further comprising:
acquiring a running direction of the work line starting from a respective middle by;
summing the grayscale values of image pixels in contact with a fan of ideal straight lines starting from the application point; and
determining a course of the work line by determining a straight line for which a sum value of the image pixels has an extreme value in comparison to sum values of the image pixels of remaining straight lines of the fan of ideal straight lines.

8. The method as claimed in claim 1, further comprising at least one of:
producing a recorded image of the work area in front of the tool;
forming a section from the recorded image of the work area;
converting the section of the recorded image into a grayscale image with a reduced number of pixels;
centering the grayscale image in an x-direction of an x-y coordinate system assigned to the section;
determining a straight line slope m (m=dx/dy) of the work line in the centered coordinate system; and
tracking the tool in the direction of the calculated slope m.

9. The method as claimed in claim 1, further comprising at least one of:
aligning a tool of an electrical tool; and
controlling the tool.

10. An electrical tool, having:
a sensor configured to detect a work line provided on a workpiece;
a controller configured to track at least one of a tool and the electrical tool along the work line; and
a computing element configured to:
acquire an image section that is adjacent to the tool or the electrical tool as a grayscale image with reference to the tool or electrical tool applied to the workpiece in a region of the work line; and
in order to acquire the work line, evaluate the grayscale image with regard to image pixels that at least one of:
make contact with the work line; and
lie in a fashion overlapping it the work line and describe the work line.
